(19) United States
(12) Patent Application Publication
(10) Pub. No.: US 2025/0339723 A1
(43) Pub. Date: Nov. 6, 2025

(54) DRIVING SIMULATOR FOR MOTOR AND NEUROLOGICAL REHABILITATION

(71) Applicants: UNIVERSITA’ DELLA CALABRIA, Rende (IT); UNIVERSITA’ DEGLI STUDI MAGNA GRAECIA DI CATANZARO, Catanzaro (IT)

(72) Inventors: Antonio AMMENDOLIA, Catanzaro (IT); Gionata FRAGOMENI, Castrolibero (IT); Nicola MAROTTA, Catanzaro (IT); Domenico MUNDO, Cosenza (IT); Francesco Igino COSCO, Rende (IT); Michele PERRELLI, Cosenza (IT); Rocco ADDUCI, Cosenza (IT)

(73) Assignees: UNIVERSITA’ DELLA CALABRIA, Rende (IT); UNIVERSITA’ DEGLI STUDI MAGNA GRAECIA DI CATANZARO, Catanzaro (IT)

(21) Appl. No.: 19/144,555

(22) PCT Filed: Dec. 20, 2023
(86) PCT No.: PCT/IB2023/062998

§ 371 Date: Jun. 30, 2025

(30) Foreign Application Priority Data
Dec. 28, 2022 (IT) 102022000026967

(51) Int. Cl. A63B 21/005; A63B 21/00; G09B 9/052

(52) U.S. Cl. CPC A63B 21/0059; A63B 21/4035; G09B 9/052

(57) ABSTRACT

A driving simulator for motor and neurological rehabilitation includes: a first steering handle and a second steering handle, kinematically independent and configured to be held respectively by a left hand and by a right hand of a patient suffering from motor deficits in correspondence with at least one upper limb and/or from cognitive disorders; a couple of electrical servomotors connected respectively to the first steering handle and to the second steering handle; an electronic control unit, connected to the electrical servomotors, and including an acquisition and control module; and a couple of angular position sensors. The driving simulator includes also at least one button and at least one lever configured to stimulate the patient to perform actions useful for the motor rehabilitation of the upper limb and for evaluating the cognitive status of the patient himself.

### CROSS REFERENCE TO THE RELATED APPLICATIONS

This application is the national phase entry of International Application No. PCT/IB2023/062998, filed on Dec. 20, 2023, which is based upon and claims priority to Italian Patent Application No. 102022000026967, filed on Dec. 28, 2022, the entire contents of which are incorporated herein by reference.

### TECHNICAL FIELD

The present invention relates to a driving simulator for motor and neurological rehabilitation.

In particular, the present invention relates to a driving simulator for motor and neurological rehabilitation including specific hardware peripherals, managed by an electronic unit that executes peculiar functional logics.

The reference technical field concerns motor rehabilitation, which can be classified as a therapeutic path that allows a patient to recover movement abilities following an injury, surgery, trauma or pathology.

### BACKGROUND

The management and re-education of peripheral nerve injuries, particularly following a stroke, require particular commitment by the rehabilitator who must know the professional physiological mechanisms and plan the recovery of motor skills with complex re-education programs, for which it is essential the use of advanced technological tools capable of implementing and supporting the work of the therapist. Stroke often involves a percentage of significant disability, with a variety of sensory, motor, cognitive and psychological symptoms, in patients who have been affected. For what concerns the upper extremity of the human body, disabilities affecting an arm or hand often cause limitations in the ability to perform essential daily activities. One of the main purposes of rehabilitation after a peripheral nerve injury is to promote the total or partial restoration of the motor function of the arms and hands, an essential factor to allow the patient to be self-sufficient in normal daily activities.

Among the different approaches to rehabilitation, physiotherapy is fundamental for improving motor functions, especially in cases where it is based on the practice of specific, repetitive and high intensity exercises. The use, in recent times, of robotic systems in rehabilitation therapies has given further impetus to the same therapies, through some exercise methods: active rehabilitation, in which a robot performs measurement functions and does not exert any force on a limb, which therefore works autonomously; passive rehabilitation, in which the robot performs the movement entirely, and the patient does not exert any effort; assisted active rehabilitation, in which the robot completes the execution of the movement when the limb does not exert enough force to complete it; resistive rehabilitation, where the robot exerts a resistant force that opposes the movement imparted by the limbs to be rehabilitated. In the state of the art, the robots used in the rehabilitation of the upper limbs are of different types and range from simple manipulators, with one or two degrees of freedom, to industrial manipulators with five or more degrees of freedom, up to wearable manipulators.

Regarding the treatment of patients affected by peripheral nerve injuries, the driving simulators, in particular, are used as a dual assessment tool, both for cognitive and driving abilities, and are useful for predicting the results of subsequent road tests. In the same field, driving simulators are effective as visual-cognitive rehabilitation tools due to their ability to improve the patient's performance both in tasks related to driving a vehicle and in other daily activities.

Several driving simulators, designed for the rehabilitation of the upper limb, to evaluate the ability of subjects suffering from neurological and/or from motor diseases to resume driving vehicles, or for both purposes, are currently known.

A first example of a known technical solution is described by the US patent application US2015024347A1 whose subject are a driving simulator apparatus and a driver rehabilitation training method using the apparatus, that includes a display unit for displaying a preset simulation driving screen, a mode selecting unit via which a normal mode, an assist mode, or a resist mode is selected by a user. The apparatus is provided also with a control unit for controlling to apply a driving force in a rotational direction of a steering wheel operated by a user when the assist mode is selected and to apply a reaction in an opposite direction to the rotational direction of the steering wheel operated by the user when the resist mode is selected.

The patent application US2017304137A1 discloses an upper-limb rehabilitation assisting device including first and second handles coupled to first and second rotating shafts and rotationally operated by hands on a paralytic limb side and a healthy limb side, first and second biosignal detecting parts that detect first and second biosignals corresponding to the paralytic limb side and the healthy limb side. The assisting device includes, in addition, first and second drive parts that drive the first and second rotating shafts, and a control part that performs a cooperative control of the first rotating shaft and the second rotating shaft. The control part controls the torques of the first and second drive parts at the time of the cooperative control of the first and second rotating shafts on the basis of the degree of cooperation between the first and second biosignals.

In addition, the text of the Italian patent application ITRM20000133A1 describes a simulation system which has the aim of measuring and recording the residual motor skills and reaction times, to visual stimuli, of people suffering from disabilities to the upper and/or lower limbs, in order to evaluate their potential ability to drive adequately equipped vehicles. In particular, a driving position replicated specifically for measuring residual motor skills includes a steering wheel equipped with manual tilt adjustment, and with a device for manually operating the accelerator control, which replicates the functions of the pedal having the same function. Furthermore, the steering wheel can be provided with devices to make it easier to grip. A device for operating the handbrake is installed next to the steering wheel, also in this case replicating the functionality of the pedal having the same function. The steering wheel and the brake pedal are connected to load cells, and the accelerator pedal to a potentiometer which, together with the load cells, is connected to a processing unit.

Finally, the patent application TW201204430A describes a bilateral system for rehabilitation and evaluation of motor recovery of the upper limbs, for post-stroke patients, which receives sensory feedback from the body of such patients regarding vision and hearing. The system allows constant training to be performed by diversifying kinematic and dynamic parameters of strength, speed and acceleration, in order to evaluate the level of rehabilitation and estimate the restoration of the patients' motor functions. The devices included in the system include at least one pair of dual-axis rods for the upper limbs, an acquisition unit of the generated physiological signals, a rehabilitation progress processing unit and a visualization unit equipped with a display.

However, driving simulators such as those mentioned suffer from intrinsic limitations, for example they do not provide differentiated methods of management of robotic manipulators, to be considered as a variety of virtual scenarios and tasks, and related types of servo-assistance available for patients undergoing rehabilitation.

### SUMMARY

The purpose of the present invention is to provide a driving simulator for motor and neurological rehabilitation which allows both to provide differentiated modes of assisted support, to the motor activities of patients, and to evaluate the motor, neurological and cognitive progress of the same patients, having, therefore, characteristics such as to overcome the limitations that still affect the current driving simulators for motor and neurological rehabilitation, with reference to the known art.

According to the present invention, a driving simulator for motor and neurological rehabilitation includes:
a first steering handle and a second steering handle, kinematically independent and configured to be held respectively by a left hand and by a right hand of a patient suffering from motor deficits in correspondence with at least one upper limb and/or from cognitive disorders, the first steering handle and the second steering handle acting as an interface means between the patient and scenarios simulated by virtual reality;
a first couple of electrical servomotors, including a first servomotor and a second servomotor connected respectively to the first steering handle and to the second steering handle, and configured to control corresponding independent angular positions of the first steering handle and the second steering handle around at least one axis of rotation;
an electronic control unit, connected to the first couple of electrical servomotors, and including an acquisition and control module configured to manage a plurality of working modes of the first couple of electrical servomotors and to evaluate advancements in a motor rehabilitation of the at least one upper limb and a cognitive status of the patient;
a first couple of angular position sensors connected to the electronic control unit; and
at least one button, configured to implement at least one pressure sensor, and at least one lever, wherein the at least one button and the at least one lever are connected to the electronic control unit and configured to stimulate the patient to perform actions, useful for the motor rehabilitation of the at least one upper limb and for evaluating the cognitive status of the patient, including:
   duplicating on the first steering handle and the second steering handle, by the at least one button and the at least one lever, functions of a vehicle simulated by virtual reality; and
   applying a pressure over the at least one button.

### BRIEF DESCRIPTION OF THE DRAWINGS

For a better understanding of the present invention, a preferred embodiment is now described, purely by way of non-limiting example, with reference to the attached drawings, in which:

FIG. 1 shows an overall view of a first embodiment of a driving simulator for motor and neurological rehabilitation, according to the invention;

FIGS. 2A-2C show, respectively, front, side and top views of the first embodiment of the driving simulator for motor and neurological rehabilitation, according to the invention;

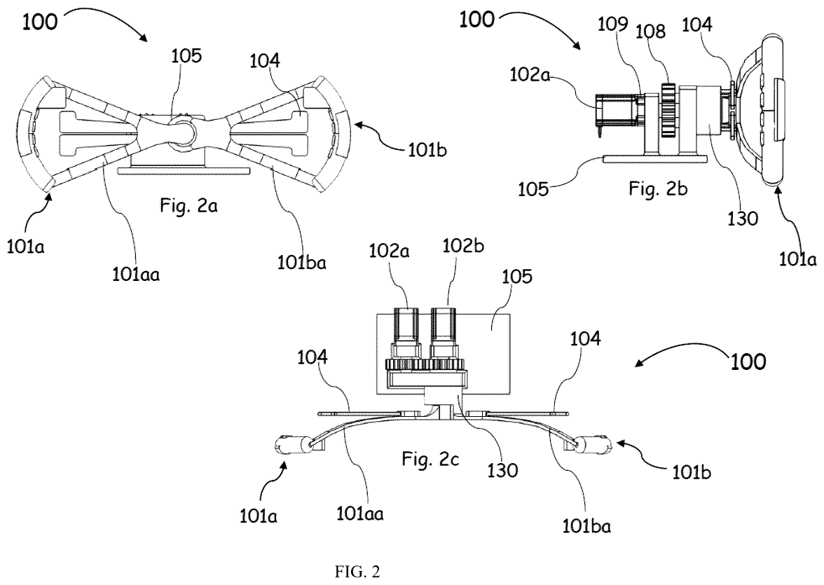

FIG. 3 shows an overall view of a second embodiment of the driving simulator for motor and neurological rehabilitation, according to the invention;

FIGS. 4A-4C show, respectively, front, side and top views of the second embodiment of the driving simulator for motor and neurological rehabilitation, according to the invention;

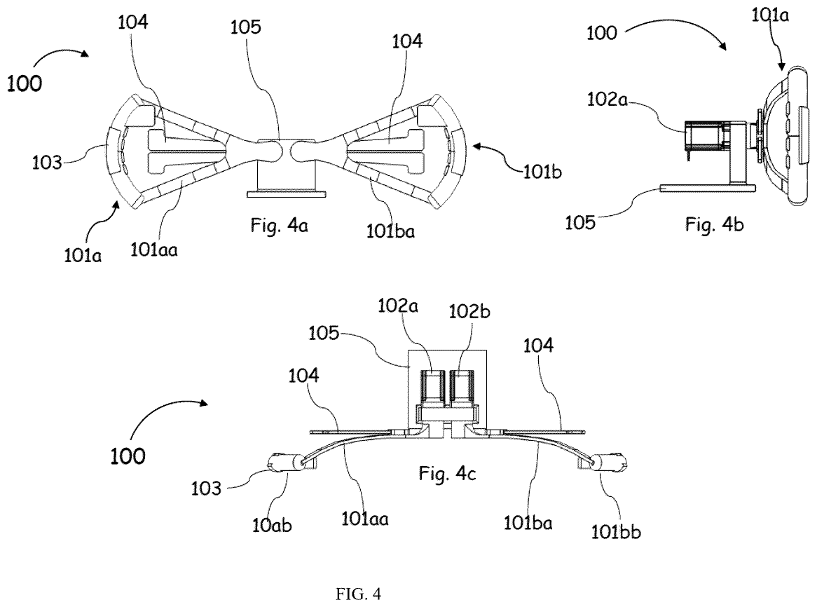

FIG. 5 shows an overall view of a third embodiment of the driving simulator for motor and neurological rehabilitation, according to the invention;

FIGS. 6A-6C show, respectively, front, side and top views of the third embodiment of the driving simulator for motor and neurological rehabilitation, according to the invention;

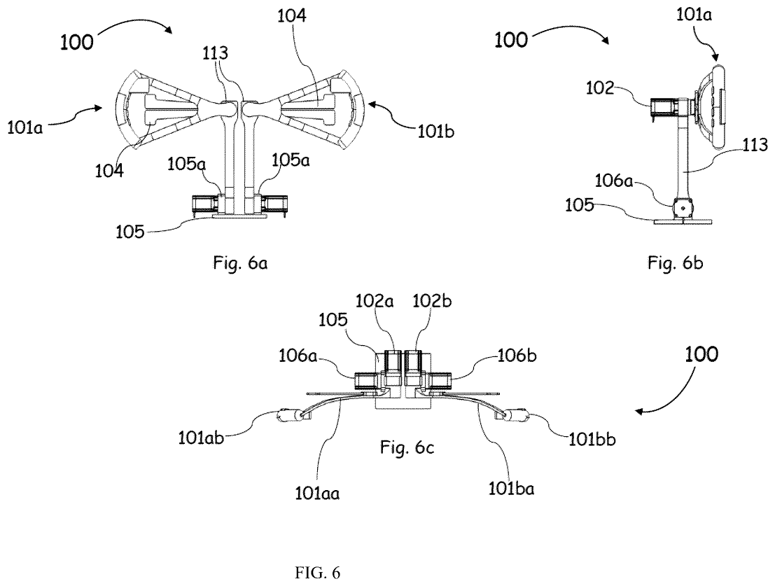

FIG. 7 shows a detailed view of a hardware part of the driving simulator for motor and neurological rehabilitation, according to the invention;

FIG. 8 shows an exploded view of the first embodiment of the driving simulator for motor and neurological rehabilitation, according to the invention;

FIG. 9 shows an exploded view of the second embodiment of the driving simulator for motor and neurological rehabilitation, according to the invention;

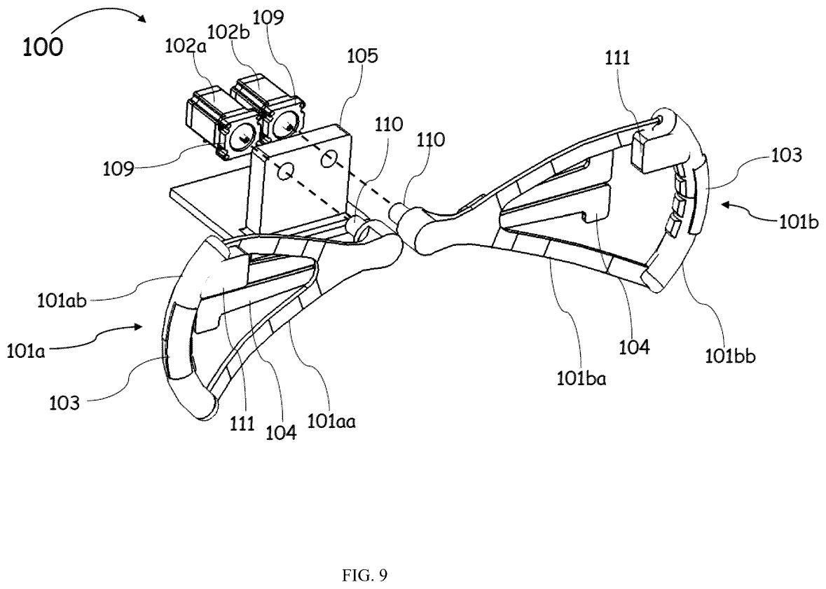

FIG. 10 shows an exploded view of the third embodiment of the driving simulator for motor and neurological rehabilitation, according to the invention;

FIG. 11 shows a block diagram explanatory of the logic of a system for a neuro-motor rehabilitation of a patient, including the driving simulator for motor and neurological rehabilitation according to the invention, together with an electronic unit included in the simulator itself and responsible for controlling the simulator on the basis of actions performed by the patient and selections made by an operator, who performs a high-level control, and by the patient himself.

### DETAILED DESCRIPTION OF THE EMBODIMENTS

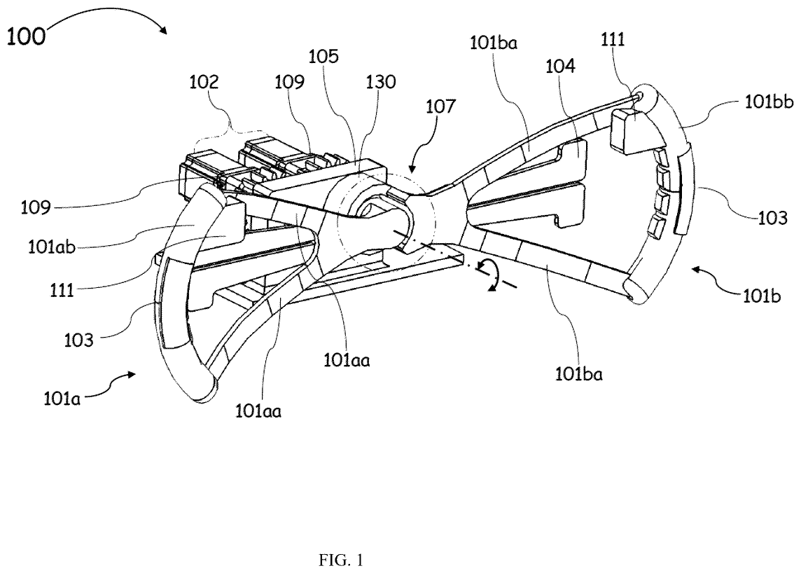

With reference to these figures and, in particular, to FIG. 1, a driving simulator for motor and neurological rehabilitation is shown, according to the invention.

In particular, the driving simulator 100 for motor and neurological rehabilitation includes:
a first steering handle 101a and a second steering handle 101b, substantially similar to two halves of a steering wheel, kinematically independent and configured to be held respectively by a left hand and by a right hand of a patient suffering from motor deficits in correspondence with at least one upper limb and/or from cognitive disorders;
a couple of electrical servomotors 102, consisting of a first electrical servomotor 102a and a second electrical servomotor 102b, connected respectively to the first steering handle 101a and to the second steering handle 101b and configured to control corresponding independent angular positions of the first steering handle 101a and of the second steering handle 101b, around at least one axis of rotation;
an electronic control unit, connected to the couple of electrical servomotors 102, including an acquisition and control module configured to manage a plurality of working modes of said couple of electrical servomotors 102 and to evaluate advancements in motor rehabilitation of at least one upper limb and cognitive status of the patient suffering from motor deficits in correspondence with at least one upper limb and/or or cognitive disorders.

According to one aspect of the invention, the first steering handle 101a and the second steering handle 101b are each composed of respective couples of spokes 101aa and 101ba and of external sections 101ab and 101bb, positioned in correspondence with ends, respectively, of the same couples of spokes 101aa and 101ba. The steering handles 101a and 101b, as anticipated, are kinematically independent and configured to be held, in correspondence with the aforementioned external sections 101ab and 101bb, respectively by a left hand and a right hand of a patient.

According to one aspect of the invention, the aforementioned external sections 101ab, 101bb are preferably implemented by toric sections.

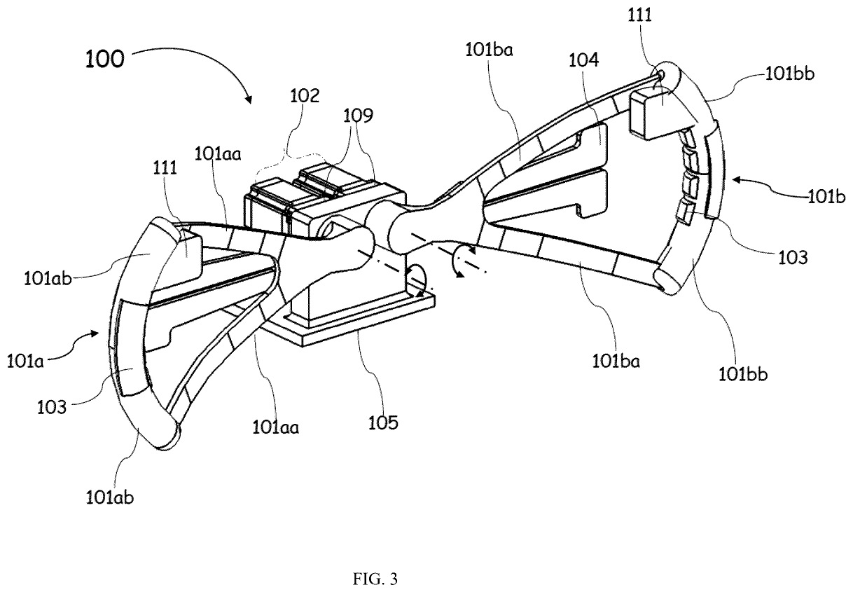

According to one aspect of the invention, the driving simulator 100 includes also a support element 105 which supports, according to a first and a second embodiment, as shown in FIGS. 1 and 3, the aforementioned first steering handle 101a and second steering handle 101b, preferably in correspondence with a front surface of the support element 105 itself.

According to one aspect of the invention, both the first electrical servomotor 102a and the second electrical servomotor 102b, included in the couple of electrical servomotors 102, are equipped with encoders and Hall effect sensors capable of angular position measurements, and are preferably positioned, for what concerns the first and the second embodiment, in correspondence with a rear surface of the support element 105. The first electrical servomotor 102a and the second electrical servomotor 102b are connected respectively to the first steering handle 101a and to the second steering handle 101b through a mechanical motion transmission system.

According to one aspect of the invention, the driving simulator 100 includes a couple of transmission shafts 110, whose shafts connect the electrical servomotors 102 to the steering handles 101a, 101b. In particular, as specified, the first servomotor 102a is connected to the first steering handle 101a, while the second servomotor 102b is connected to the second steering handle 101b.

According to one aspect of the invention, the driving simulator 100 includes a couple of mechanical torque sensors 109 consisting of a first torque sensor connected to the first servomotor 102a and configured to detect a mechanical torque acting on the first steering handle 101a, and a second torque sensor connected to the second servomotor 102b and configured to detect a mechanical torque acting on the second steering handle 101b. The mechanical torque sensors 109 allow a torque control of the servomotors 102.

According to one aspect of the invention, the first and second electrical servomotors 102a, 102b are configured to control an angular position of the first steering handle 101a and of the second steering handle 101b, detected by the aforementioned encoders and Hall effect sensors, originated from independent rotations of the steering handles 101a, 101b around at least one axis of rotation and with respect to a rest position of the steering handles 101a, 101b.

According to one aspect of the invention, the angular position of the two steering handles 101a, 101b is to be understood as the angle that each handle forms, as a consequence of the aforementioned rotation, with respect to the aforementioned rest position of each steering handles 101a, 101b, characterized by the absence of mechanical torque applied to the shafts 110, i.e., to the first and second steering handles 101a, 101b, with such handles aligned with each other as shown in FIG. 1. Under ideal conditions, with both upper limbs free from motor deficits and able to exert, in use, the same mechanical torque to the steering handles 101a, 101b, their rotations would be identical or, in other words, the difference between the angular positions of the two handles would be constant and equal to 180 degrees, with the two handles constantly aligned.

According to one aspect of the invention, each mechanical torque sensor 109 and each angular position sensor is connected to the electronic control unit and to the respective first or second electrical servomotor 102a, 102b.

According to one aspect of the invention, the angular position sensors and the mechanical torque sensors 109, are integrated into separate housings or within a single case.

According to one aspect of the invention, the electronic control unit consists of an external processor, not shown in the figure, connected to the steering handles 101a, 101b by means of, for example, a USB connection or a wireless connection through respective interfaces with which both the electronic control unit and the steering handles are provided.

According to one aspect of the invention, in an alternative configuration the electronic control unit, preferably a PCB board based on a microcontroller, on an x86/x64 CPU or on other data processing microsystems, is housed in the support element 105.

According to one aspect of the invention, the acquisition and control module is saved to at least one memory unit, for example a solid-state flash memory module, connected to the electronic control unit.

According to one aspect of the invention, the driving simulator 100 includes visualization means, able to be used by the patient, of the driving scenarios simulated by means of virtual reality. Such visualization means include, for example, a screen and/or a wearable display device such as a VR viewer.

According to one aspect of the invention, the driving simulator 100 includes means for reproducing hearing stimulations and acoustic effects. Such means are, for example, implemented through speakers, headphones, earphones, connected to an audio reproduction system.

According to one aspect of the invention, the steering handles 101a, 101b can be assimilated to a robotic manipulator having ‘n’ degrees of freedom, DoF, constituting and acting as a means of interface between the patient and driving scenarios simulated by means of virtual reality, reproduced through the visualization means and/or the means for reproducing hearing stimulations and acoustic effects.

According to another aspect of the invention, the first steering handle 101a and the second steering handle 101b are connected to the respective mechanical torque sensor 109 and to the angular position sensor with which the electrical servomotors 102 are provided and that, as specified, are connected to the electronic control unit that acquires, digitizes and stores the electrical signals generated by the aforementioned sensors.

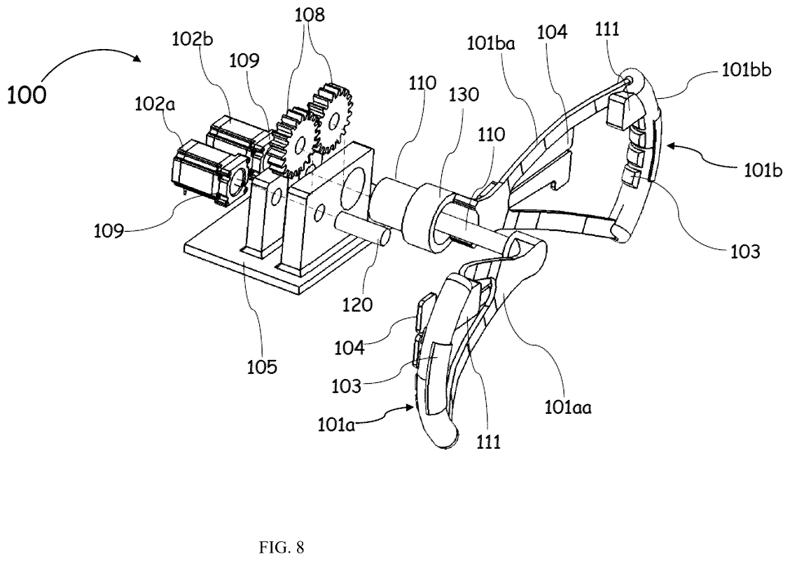

According to one aspect of the invention, in the first embodiment, as shown in FIGS. 1 and 8, the first steering handle 101a and the second steering handle 101b share the same axis of rotation. In particular, one end of the second steering handle 101b surrounds a corresponding end of the first steering handle 101a. The second steering handle 101b in fact includes, in correspondence with the aforementioned end, a cylindrical body 130 in which the transmission shaft 110 of the first steering handle 101a is housed. The axes of rotation of the first steering handle 101a and of the second steering handle 101b are in this case, as said, coincident, although their rotations are kinematically independent.

According to one aspect of the invention, in such a first embodiment the mechanical motion transmitting system to the first steering handle 101a and to the second steering handle 101b, includes, preferably, a couple of gear wheels 108. In detail, a first gear wheel is connected to the first electrical servomotor 102a and rotating engages a second gear wheel which is connected to the transmission shaft 110 of the first steering handle 101a. The second steering handle 101b is directly connected to the second electrical servomotor 102b by means of its own transmission shaft 110 fixed to the aforementioned cylindrical body 130, compared to which the transmission shaft 110 itself has preferably a smaller section. FIG. 8 also shows a transmission element 120 which has the function of connecting the first electrical servomotor to the first gear wheel.

According to another aspect of the invention, in the first embodiment, alternatively to the couple of gear wheels 108, the mechanical motion transmitting system to the first steering handle 101a uses a transmission belt, not shown in the figures, which interconnects the first electrical servomotor 102a to the transmission shaft 110 of the aforementioned first steering handle 101a.

According to one aspect of the invention, in this first embodiment the couple of mechanical torque sensors 109 is made up of a first torque sensor shrank on the transmission element 120 of the first steering handle 101a, and of a second torque sensor shrank on the transmission shaft 110 pertaining the second steering handle 101b. Furthermore, in this first embodiment, as visible in FIG. 1, the cylindrical body 130 at one end of the second steering handle 101b, and the corresponding adjacent end of the first steering handle 101a from which the transmission shaft 110 of the same first steering handle 101a branches, constitute a rotational kinematic pair 107.

According to another aspect of the invention, as better shown in FIG. 3, in the second embodiment the first steering handle 101a and the second steering handle 101b are pivoted around corresponding portions, preferably at the same height, of the front surface of the support element 105 and are configured to rotate around respective axes of rotation, preferably parallel.

According to another aspect of the invention, both in the first and in the second embodiment, the first and second steering handles 101a, 101b, or robotic manipulator parts, have two degrees of freedom, one for each steering handle 101a, 101b.

According to one aspect of the invention, the plurality of working modes of the couple of electrical servomotors 102, managed by the acquisition and control module, as part of a series of rehabilitation tasks and evaluation of the visual-cognitive state of the patient, by means of the driving simulator 100, includes at least one working mode included within the group consisting of:
a passive working mode, in which a handle, between the first and the second steering handle 101a, 101b, which is previously associated with at least one upper limb suffering from motor deficit and held by one of the two hands of the patient, is rotated by the corresponding first electrical servomotor 102a or second electrical servomotor 102b in order to equal the related rotation of the other steering handle rotated by the patient using the hand belonging to the upper limb not affected by motor deficit;
an active working mode, in which both the first steering handle 101a and the second steering handle 101b are rotated by the patient and the electronic control unit compares, by means of the mechanical torque sensor 109 and the angular position sensors, the angular positions, or rotations, and the torques exerted on the steering handles 101a, 101b respectively by the upper limb affected by motor deficit and by the other upper limb, not suffering from motor deficit;
an active assisted working mode, in which the rotation of a steering handle, between the first steering handle 101a and the second steering handle 101b, associated with the upper limb affected by motor deficit, is assisted by the corresponding first or second electrical servomotor so as to equal the related rotation, of the remaining handle rotated by the patient using the upper limb not affected by motor deficit, in order to allow the completion of a rehabilitation task assigned to the patient himself;
a resistive working mode, in which both the first and the second electrical servomotor 102a, 102b exert a driving torque resistant to rotations, able to modify the angular positions exerted by the patient on the first steering handle 101a and on the second steering handle 101b.

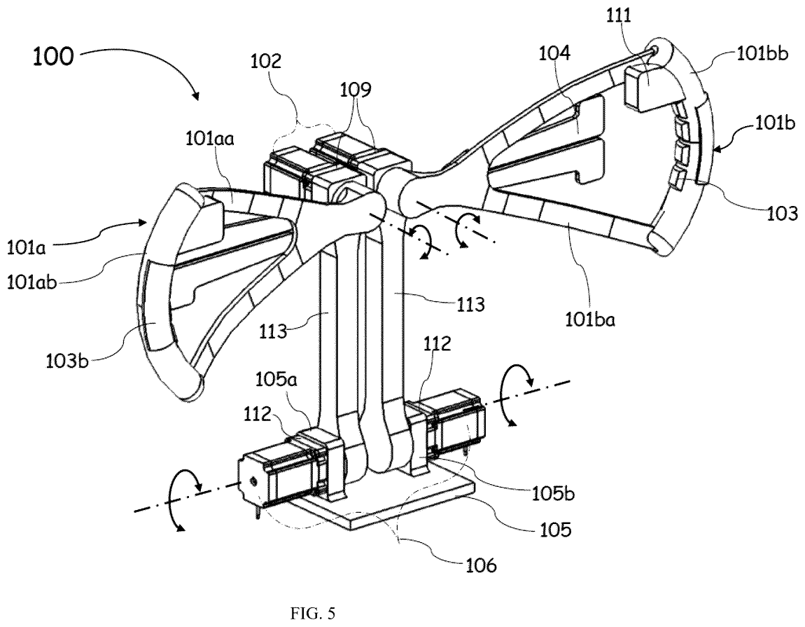

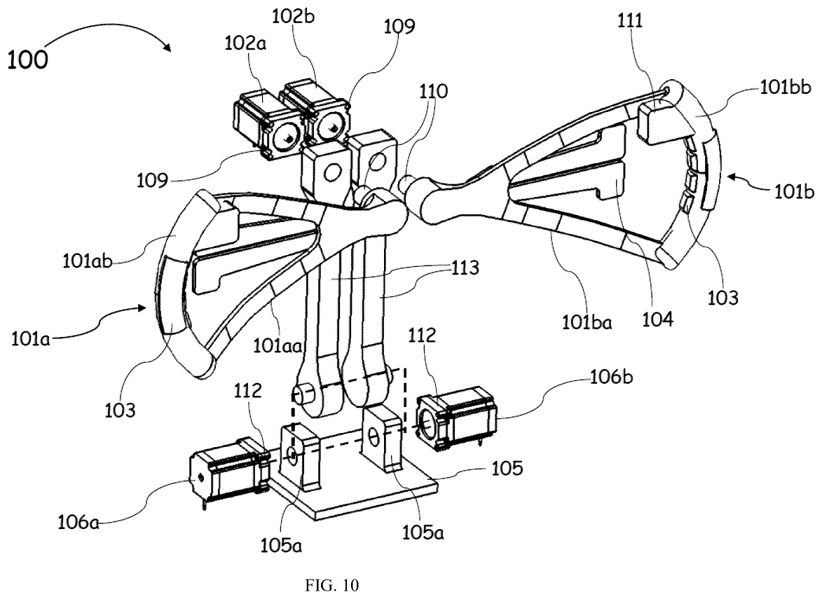

According to one aspect of the invention, in a third embodiment shown in FIGS. 5 and 10, the driving simulator 100 includes a further couple of electrical servomotors 106, in addition to the couple of electrical servomotors 102, connected to the electronic control unit and consisting of a third electrical servomotor 106a and a fourth electrical servomotor 106b mounted, as visible in FIG. 5 and FIG. 10, in correspondence with the support element 105

According to one aspect of the invention, in the aforementioned third embodiment the driving simulator 100 includes a further couple of mechanical torque sensors 112, connected respectively to the third electrical servomotor 106a and to the fourth electrical servomotor 106b, as well as to the electronic control unit. Two further motion transmission shafts are connected to the electronic control unit, with each of such further transmission shafts being connected to a corresponding further electrical servomotor 106a, 106b.

According to one aspect of the invention, in the third embodiment the driving simulator 100 includes a further couple of angular position sensors connected to the electronic control unit. Furthermore, the two further angular position sensors are connected to a respective electrical servomotor included between the third servomotor 106a and the fourth servomotor 106b.

According to one aspect of the invention, the third and fourth electrical servomotors 106a, 106b, as visible in FIG. 5, are connected respectively to the first steering handle 101a and to the second steering handle 101b by means of support arms 113, which together with the same steering handles implement the functions of cloches, possibly balanced statically. In detail, the third and fourth electrical servomotors 106a, 106b are connected to a corresponding support arm 113 in correspondence with lower ends of such support arms, that in turn are hinged to the support element 105 by means of respective coupling means 105a, 105b, visible in FIGS. 5 and 10.

According to one aspect of the invention, each steering handle 101a, 101b, is connected to a respective upper end, opposite to the lower end, of a corresponding support arms 113. The aforementioned third and fourth electrical servomotors 106a, 106b are configured to control corresponding, additional, independent rotations and consequent additional independent angular positions of the same steering handles 101a, 101b around a further axis of rotation, preferably orthogonal to the axes of rotation previously described.

According to one aspect of the invention, in the third embodiment the first and the second electrical servomotors 102a, 102b are connected, respectively to the first steering handle 101a and to the second steering handle 101b, by means of the respective transmission shaft 110, in correspondence with the aforementioned upper ends of the support arms 113.

According to another aspect of the invention, in such a third embodiment the steering handles 101a, 101b allow the patient suffering from motor deficits in correspondence with at least one upper limb and/or from cognitive disorders to be interfaced with a model of flying plane, within scenarios of flights simulated, as previously, by means of virtual reality.

According to another aspect of the invention, in the aforementioned third embodiment the robotic manipulator has four degrees of freedom, two for each steering handle 101a, 101b.

According to one aspect of the invention, in the second and third embodiments each of the mechanical torque sensors 109 is preferably shrank on a respective transmission shaft 110.

According to one aspect of the invention, in the third embodiment each of the further mechanical torque sensors 112 is shrank on a respective further transmission shaft concerning the third or fourth electrical servomotor 106.

According to one aspect of the invention, the driving simulator 100 includes at least one button 103 positioned in correspondence with at least one internal and/or external portion of the first steering handle 101a and of the second steering handle 101b, preferably of the first external section 101ab and of the second external section 101bb, connected to the electronic control unit and configured to stimulate the patient, suffering from motor deficits in at least one upper limb and/or from cognitive disorders, to perform actions useful for the motor rehabilitation of the at least one upper limb and to assess the cognitive state of the patient himself.

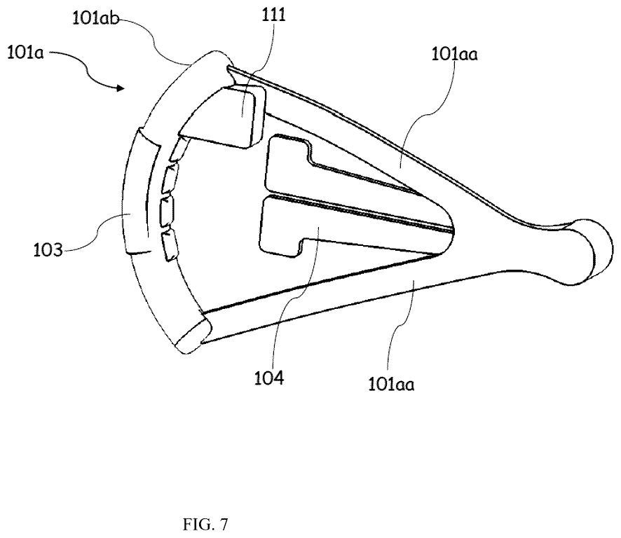

According to one aspect of the invention, the at least one button 103, is also designed to implement at least one force/pressure sensor, for example a finger pressure sensor and/or a palm pressure sensor, as shown for example in FIGS. 1, 3 and 7 and designed to detect the motor conditions of the patient and evaluate the progress of the rehabilitation therapy.

According to one aspect of the invention, the driving simulator 100 includes at least one lever 104, placed in correspondence with at least one external rear portion of the first steering handle 101a and of the second steering handle 101b, preferably of the spokes 101aa and of the spokes 101ba, connected to the electronic control unit and configured to stimulate the patient suffering from motor deficits in correspondence with at least one upper limb and/or from cognitive disorders to perform actions, useful both for the motor rehabilitation of the upper limb and to assess the cognitive state of the patient himself.

According to one aspect of the invention, the aforementioned actions, useful for the motor rehabilitation of the upper limb and for evaluating the cognitive state of the patient, which can be performed through the at least one button 103 and lever 104, include duplicating on the first and second steering handle 101a, 101b, in particular for the first and the second embodiment, functions of a vehicle, simulated by means of virtual reality, in reality usually operated by pedals or by other actuators, for example gear changing, acceleration, braking and activation of direction indicators, as well as, as anticipated, the application of pressure on the regions of the steering handles 101a, 101b where the sensors 103 are positioned.

According to one aspect of the invention, the driving simulator 100 includes, in correspondence with the upper portions of each steering handle 101ab, 101bb, control buttons 111 of the same simulator, able to be operated by the patient suffering from motor deficits in correspondence with at least one upper limb and/or from cognitive disorders.

Advantageously according to the invention, the duplication of the driving functions on the steering handles 101a, 101b allows full control of the simulated vehicle through the upper limbs only, making the driving simulator 100 also usable by patients suffering from motor deficits affecting the lower limbs.

Advantageously according to the invention, the third embodiment, thanks to the additional degrees of freedom, allows complex rehabilitation tasks to be administered to the patient, so ensuring relevant activation of the muscular system of the upper limb and effectiveness of the therapy.

Advantageously according to the invention, if both upper limbs are affected by motor deficits, the driving simulator 100 allows motor rehabilitation exercises/tasks to be administered to both limbs.

Advantageously according to the invention, the mechanical torque sensors 109 and 112 allow to detect the mechanical force/torque exerted by the patient on the corresponding steering handle, 101a or 101b, allowing to monitor the progress achieved during the motor, neurological and/or cognitive rehabilitation process.

Advantageously according to the invention, if both upper limbs are affected by motor deficits, the driving simulator 100, in the aforementioned passive, active and active assisted working modes, characterized by a predominant action of the electrical servomotors 102a, 102b, implements functions typical of an autonomously driven vehicle.

According to one aspect of the invention, the driving simulator 100 is connected to external support devices configured to aid the motor rehabilitation of the at least one upper limb of the patient. In detail, in order to allow the execution of rehabilitation movements, even for patients suffering from really limited motor skills of at least one upper limb, the driving simulator 100 is able to be interfaced to an external support device connected in correspondence with one end to one of the two steering handles 101a, 101b, i.e., the handle corresponding to the upper limb subject to motor rehabilitation, and with the other end to the limb itself, so as to allow that the weight of the limb can be counteracted, i.e., balanced, by a torque exerted by the related electrical servomotor on the axis of rotation of the handle. Such an external support device may consist of a single arm, specifically shaped, or of an adaptable, active or passive exoskeleton. The support device may be in turn provided with further sensors, such as strain gauges, force and/or torque sensors, which allow the evolutionary steps of the therapy to be monitored objectively, using indirect measurement techniques of the muscular effort made by the patient. At the same time, the control of the steering handle, during the motor rehabilitation, can be improved.

According to another aspect of the invention, such external support devices include at least one device included within the group consisting of:
wearable devices;
exoskeletons or arms, as previously described;
cameras;
electromyographs.

According to another aspect of the invention, the driving simulator 100 includes a pedal set that allows the patient to exert control functions to the vehicle simulated by means of virtual reality by activating, through the lower limbs, clutch, accelerator and brake pedals.

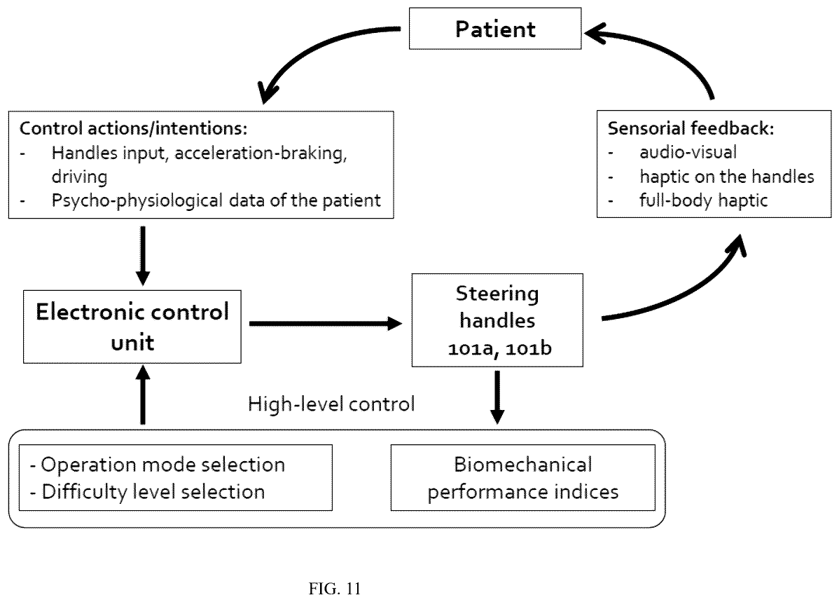

According to another aspect of the invention, the driving simulator 100 includes a platform characterized by one or more degrees of freedom, capable of moving a combined simulator-patient system, thus providing the same patient with haptic feedback through a movement, for example of vibratory type, in one or more directions, within a set of functions schematized in FIG. 11.

According to another aspect of the invention, the driving simulator 100 includes, along the axis of rotation between each electrical servomotor 102a, 102b and further electrical servomotor 106a, 106b and the corresponding steering handle 101a, 101b, a corresponding electromagnetic or electromechanical brake.

Advantageously according to the invention, such electromagnetic or electromechanical brakes act as a further motor rehabilitation support, allowing the provision of an additional resistant torque, or as a safety support, stopping the entire driving simulator 100 in the event of an emergency.

According to one aspect of the invention, the acquisition and control module consists of a computer program product, i.e., a specific software application, saved to the memory unit and configured to acquire the working status of the couple of mechanical torque sensors 109 and/or of the further couple of mechanical torque sensors 112, of the angular position sensors and/or of the further angular position sensors, and of the at least one button 103 and lever 104.

According to one aspect of the invention, the acquisition and control module evaluates advancements in the motor rehabilitation of the upper limb and the cognitive status of the patient, through processing of the digitized and archived data originating from the electrical signals acquired by the aforementioned mechanical torque sensors 109 and further mechanical torque sensors 112, buttons 103 and levers 104. In particular, in order to monitor the progress of the motor rehabilitation, the acquisition and control module acquires on subsequent instants, at a programmable time frequency, both the amount of the mechanical torque that the upper limb subjected to the therapy is able to exert on the corresponding steering handle 101a or 101b, and the pressures applied to the buttons 103, and the degree of precision with which the steering handle 101a or 101b itself follows a reference angular position or, in other words, the difference between the angular positions of the aforementioned first steering handle 101a and second steering handle 101b, ideally equal to 180 degrees. In the event of patients suffering from motor deficit in correspondence with only one limb, the reference position is defined on the basis of the rotation of the steering handle operated by the limb not affected by the deficit. If the rehabilitation involves both upper limbs or is solely of a neurological type, the reference angular position is defined as the rotation of the steering handles 101a, 101b which allows the virtual vehicle to follow the proposed driving scenario with the related simulated trajectories.

According to another aspect of the invention, in all three embodiments the driving simulator 100 includes a software interface that allows an operator, who is entrusted with a high-level control, to: selecting the working mode of the driving simulator 100, starting from the indication, made by the same operator, of the upper limb affected by motor deficits; monitoring the progress of rehabilitation therapy on the basis of biomechanical performance indices obtained from physical quantities such as forces, displacements, speed, which the simulator itself allows to measure through specific sensors; selecting levels of increasing complexity of the tasks administered to the patient in question, based on the current state and the progress detected by the driving simulator 100.

Therefore, the driving simulator for motor and neurological rehabilitation according to the invention allows to administer different types of robotic support to motor rehabilitation activities of patients suffering from motor deficits following an injury, a surgery, a trauma or a clinical disease.

Another advantage of the driving simulator for motor and neurological rehabilitation according to the invention is that it allows to evaluate the cognitive status of patients suffering from deficits concerning intellectual abilities following an injury, a surgery, a trauma or a clinical disease.

A further advantage of the driving simulator for motor and neurological rehabilitation according to the invention is that it can be interfaced to external devices able to support a motor rehabilitation.

A further advantage of the driving simulator for motor and neurological rehabilitation according to the invention is that it can be interfaced to a platform for moving the system, thus generating a vibratory motion in the patient, through which it can be signaled to the patient, exploiting haptic feedbacks, a driving behavior that distances the virtual vehicle from the path reproduced in the simulation environment, in order to stimulate the patient himself to take corrective actions. Furthermore, the platform may be exploited to provide the patient with motion feedback to stimulate the vestibular perception of lateral and longitudinal acceleration aligned with the simulated maneuver, e.g., accelerating or breaking maneuver, or cornering.

Furthermore, the driving simulator for motor and neurological rehabilitation according to the invention allows to recreate virtual scenarios of driving road or air vehicles, having variable complexity depending on the state of advancement of the rehabilitation and on the level of difficulty of the rehabilitation task that a health professional administers.

Furthermore, the driving simulator for motor and neurological rehabilitation according to the invention is easy to use.

Finally, the driving simulator for motor and neurological rehabilitation according to the invention is inexpensive and involves reduced complexity for what concerns prototyping and industrialization phases.

It is finally clear that the driving simulator for motor and neurological rehabilitation, described and illustrated herein, may be subject to modifications and variations without departing from the protective scope of the present invention, as defined in the appended claims.

What is claimed is:

1. A driving simulator for motor and neurological rehabilitation, comprising:
a first steering handle and a second steering handle, kinematically independent and configured to be held respectively by a left hand and by a right hand of a patient suffering from motor deficits in correspondence with at least one upper limb and/or from cognitive disorders, the first steering handle and the second steering handle acting as an interface means between the patient and scenarios simulated by virtual reality;
a first couple of electrical servomotors, comprising a first servomotor and a second servomotor connected respectively to the first steering handle and to the second steering handle, and configured to control corresponding independent angular positions of the first steering handle and the second steering handle around at least one axis of rotation;
an electronic control unit, connected to the first couple of electrical servomotors, and comprising an acquisition and control module configured to manage a plurality of working modes of the first couple of electrical servomotors and to evaluate advancements in a motor rehabilitation of the at least one upper limb and a cognitive status of the patient;
a first couple of angular position sensors connected to the electronic control unit; and
at least one button, configured to implement at least one pressure sensor, and at least one lever, wherein the at least one button and the at least one lever are connected to the electronic control unit and configured to stimulate the patient to perform actions, useful for the motor rehabilitation of the at least one upper limb and for evaluating the cognitive status of the patient, comprising:
duplicating on the first steering handle and the second steering handle, by the at least one button and the at least one lever, functions of a vehicle simulated by virtual reality; and
applying a pressure over the at least one button.

2. The driving simulator according to claim 1, further comprising a support element supporting the first steering handle and the second steering handle, in correspondence with a front surface, and the first couple of electrical servomotors in correspondence with a rear surface.

3. The driving simulator according to claim 1, further comprising a couple of transmission shafts connecting a first electrical servomotor and a second electrical servomotor of the first couple of electrical servomotors respectively to the first steering handle and to the second steering handle.

4. The driving simulator according to claim 1, further comprising a first couple of mechanical torque sensors, each being connected to a respective electrical servomotor and configured to detect a mechanical torque acting on the respective first steering handle or second steering handle, wherein each of the first couple of angular position sensors is connected to a respective electrical servomotor and configured to detect an angle formed, respectively, by the first steering handle and by the second steering handle with respect to a rest position of the first steering handle and the second steering handle, wherein the rest position is defined by an absence of mechanical torque applied to the first steering handle and to the second steering handle.

5. The driving simulator according to claim 1, wherein the at least one button is positioned in correspondence with at least one internal and/or external portion of the first steering handle and of the second steering handle, and the at least one lever is positioned in correspondence with at least one external rear portion of the first steering handle and of the second steering handle.

6. The driving simulator according to claim 1, further comprising visualization means, by the patient, of the scenarios simulated by virtual reality, and means for reproducing hearing stimulations and acoustic effects.

7. The driving simulator according to claim 3, wherein the second steering handle comprises in correspondence with one end a cylindrical body, wherein the couple of transmission shafts of the first steering handle are housed in the cylindrical body, and
wherein the driving simulator further comprises a couple of gear wheels comprising a first gear wheel and a second gear wheel, wherein the first gear wheel is connected to the first electrical servomotor and rotating engages the second gear wheel interconnected to the transmission shaft of the first steering handle, or a transmission belt interconnecting the first electrical servomotor to the transmission shaft of the first steering handle.

8. The driving simulator according to claim 4, wherein the plurality of working modes of the first couple of electrical servomotors comprises at least one working mode comprised within the group comprising:
a passive working mode, wherein in the passive working mode, a steering handle within the first steering handle and the second steering handle, associated with the at least one upper limb suffering from motor deficit, is rotated by the corresponding first servomotor or second servomotor so as to equal the related rotation of the other steering handle, rotated by the patient;
an active working mode, wherein in the active working mode, the first steering handle and the second steering handle are rotated by the patient and the electronic control unit compares, by the first couple of mechanical torque sensors and the first couple of angular position sensors, the angular positions exerted on the first steering handle and the second steering handle by the at least one upper limb suffering from motor deficit and by the other upper limb;
an active assisted working mode, wherein in the active assisted working mode, a rotation of the steering handle within the first steering handle and the second steering handle, associated with at the least one upper limb suffering from motor deficit, is assisted by the corresponding first servomotor or second servomotor so as to equal the related rotation of the other handle, rotated by the patient; and
a resistive working mode, wherein in the resistive working mode, the first servomotor and the second servomotor exert a driving torque able to modify the angular positions exerted by the patient on the first steering handle and the second steering handle.

9. The driving simulator according to claim 1, wherein the driving simulator is connected to external support devices configured to aid the motor rehabilitation of the at least one upper limb of the patient, and the external support devices comprises at least one device comprised within the group comprising:
wearable devices;
exoskeletons or arms, connected in correspondence with a first end to the first steering handle or to the second steering handle, corresponding to the upper limb subject to motor rehabilitation, and with a second end to the upper limb in order to balance a weight of the upper limb by an additional torque exerted by the related electrical servomotor;
cameras; and
electromyographs.

10. The driving simulator according to claim 1, further comprising a platform having at least one degree of freedom configured to move the driving simulator and the patient and to provide the patient with a haptic feedback by a movement in one or more directions, and a pedal set configured to operate, by the patient, control functions of a vehicle simulated by virtual reality.

11. The driving simulator according to claim 1, further comprising:
a second couple of electrical servomotors, connected to the electronic control unit, and comprising:
a third electrical servomotor and a fourth electrical servomotor, connected respectively to the first steering handle and to the second steering handle by a corresponding support arm and configured to control corresponding independent angular positions of the first steering handle and the second steering handle around a further axis of rotation.

12. The driving simulator according to claim 11, further comprising:
a second couple of mechanical torque sensors, wherein each of the second couple of mechanical torque sensors is connected to the electronic control unit and to a corresponding further electrical servomotor, and
a second couple of angular position sensors connected to the electronic control unit and to a respective further electrical servomotor.

13. The driving simulator according to claim 11, further comprising electromagnetic or electromechanical brakes mounted between each electrical servomotor and further electrical servomotor and the corresponding steering handle.

14. The driving simulator according to claim 1, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.

15. The driving simulator according to claim 2, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.

16. The driving simulator according to claim 3, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.

17. The driving simulator according to claim 4, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.

18. The driving simulator according to claim 5, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.

19. The driving simulator according to claim 6, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.

20. The driving simulator according to claim 7, wherein the acquisition and control module comprises a computer program product saved to at least one memory unit connected to the electronic control unit, and the acquisition and control module is configured to acquire a working status of the first couple of angular position sensors and/or of a second couple of angular position sensors, of a first couple of mechanical torque sensors and/or of a second couple of mechanical torque sensors, of the at least one button and of the at least one lever in order to evaluate the advancements in motor rehabilitation of the at least one upper limb and the cognitive status of the patient, wherein the advancements are evaluated by detecting on successive instants, at a programmable time frequency, the mechanical torque given by the upper limb suffering from motor deficit to the first steering handle or to the second steering handle, a difference between the angular positions of the first steering handle and the second steering handle and the pressure applied to the at least one button.
